(19) United States
(12) Patent Application Publication
(10) Pub. No.: US 2025/0044398 A1
(43) Pub. Date: Feb. 6, 2025

(54) METHOD FOR DETERMINING THE POSITION OF AN END DEVICE OF A WILDFIRE EARLY DETECTION SYSTEM

(71) Applicant: DRYAD NETWORKS GMBH, Eberswalde (DE)

(72) Inventors: Carsten BRINKSCHULTE, Berlin (DE); Marco BÖNIG, Dortmund (DE)

(73) Assignee: DRYAD NETWORKS GMBH, Eberswalde (DE)

(21) Appl. No.: 18/719,878

(22) PCT Filed: Dec. 13, 2022
(86) PCT No.: PCT/EP2022/085710

§ 371 Date: Jun. 14, 2024

(30) Foreign Application Priority Data
Dec. 15, 2021 (DE) 10 2021 133 219.2

(51) Int. Cl. G01S 5/02; A62C 3/02

(52) U.S. Cl. CPC G01S 5/0289; A62C 3/0271; G01S 5/0264; G01S 2205/001

(57) ABSTRACT

The invention relates to a method for determining the position of an end device of a wildfire early detection system having the method steps of identifying the end device, detecting the dispensing position of the end device, assigning the dispensing position to an identified end device, and storing data from the dispensing position and the identification of the end device. The invention also relates to a wildfire early detection system comprising a large number of end devices and a server, wherein the exact position of the end devices in the installation is unknown.

The invention relates to a method for determining the position of an end device of a wildfire early detection system having the method steps of identifying the end device, recording the dispensing position of the end device, assigning the dispensing position to an identified end device, and storing data from the dispensing position and the identification of the end device. The invention also relates to a wildfire early detection system comprising a large number of end devices and a server, wherein the exact position of the end devices in the installation is unknown.

### PRIOR ART

Systems for early detection of wildfires are known. For this purpose, the area to be monitored is monitored by means of sensors. These sensors are, for example, rotatable cameras, but they have the disadvantage that they are less effective at night. Monitoring from a high orbit by means of an IR camera installed in a satellite has the disadvantage that the satellite is not geostationary, so it requires a certain amount of time to complete one orbit, during which the area is not monitored or the geostationary satellites only supply images having a very low resolution, so that wildfires can only be detected from a certain size, thus usually too late. A satellite is also expensive to purchase, maintain and especially when launching the satellite. Monitoring by mini-satellites in low orbit usually requires a number of satellites, which are also expensive to launch. Satellite monitoring also involves high carbon dioxide emissions during launch.

It makes more sense to monitor the area using a large number of inexpensive sensors arranged in end devices producible in series. These end devices often require only a small amount of energy, either because they are not continuously operated or because the sensors themselves are designed to be very energy efficient. The devices are part of a network, such as a LoRaWAN. The end devices and gateways are distributed throughout the area to be monitored and deliver data to a base station via radio connection.

LoRaWAN uses a star topology network architecture in which all the end devices communicate via the most suitable gateway. These gateways handle routing and, if more than one gateway is within range of an end device and the local network is congested, they can also redirect communication to an alternative.

However, some other IoT protocols (e.g. ZigBee or Z-Wave) use so-called mesh network architectures to increase the maximum distance of an end device from a gateway. The end devices in the mesh network forward the messages to each other until they reach a gateway, which transfers the messages to the Internet. Mesh networks program themselves and dynamically adapt to environmental conditions without the need for a master controller or hierarchy. However, in order to be able to forward messages, the end devices of a mesh network have to be ready to receive either constantly or at regular intervals and cannot be put into the idle state for long periods of time. The result is a higher energy requirement of the node end devices for forwarding messages to and from the gateways and a resulting reduction in battery life.

The star network architecture of LoRaWAN, on the other hand, allows the end devices to enter the energy-saving idle state for long periods of time, thereby ensuring that the battery of the end devices is put under as little load as possible and can therefore be operated for several years without having to change the battery. The gateway functions as a bridge between simple protocols optimized for battery life (LoRa/LoRaWAN), which are better suited for resource-limited end devices, and the Internet Protocol (IP), which is used to provide IoT services and applications. After the gateway has received the data packets from the end device via LoRa/LoRaWAN, it sends them via the Internet Protocol (IP) to a network server, which in turn has interfaces to IoT platforms and applications.

Currently, these end devices and gateways are individually arranged manually, for example on trees, and their position is recorded to localize an occurring wildfire. However, this method is ineffective, especially in areas that are difficult to access. Above all, this type of installation of the sensor network is very time-consuming and therefore cost-intensive.

It is therefore the object of the invention to provide an improved method for installing a wildfire early detection system, using which a wildfire early detection system can be installed and configured inexpensively, quickly, and reliably. It is also an object of the present invention to provide an improved end device, using which a wildfire early detection system can be installed and configured inexpensively, quickly, and reliably. It is a further object of the present invention to provide a method for determining the position of an end device of a wildfire early detection system, with which a wildfire early detection system can be installed and configured inexpensively, quickly, and reliably.

### DESCRIPTION OF THE INVENTION

The task is achieved by means of the method for determining the position of an end device of a wildfire early detection system of claim 1. Advantageous embodiments of the invention are set out in the dependent claims.

The method according to the invention for determining the position of an end device of a wildfire early detection system has four method steps: In the first method step, the end device is identified. To uniquely identify each end device, each end device has a separate and distinguishable ID identifier. This ID is readable, for example, using a barcode, a QR code, or an RFID chip located on the end device and/or via NFC.

In the second step of the method, the dispensing position of the end device is recorded. The dispensing position is the geographical position at which an end device is dispensed by a dispensing device. The dispensing position is usually different from the final position of the end device, wherein the final position of an end device denotes the (true) position of an end device within a wildfire early detection system.

In the third method step, the dispensing position is assigned to an identified end device. By recording the dispensing position and identifying each end device, the dispensing position of each end device is precisely determinable.

In the fourth method step, data from the dispensing position and the identification of the end device are stored. In addition, the dispensing position of each end device is assigned to the respective end device. The dispensing position of each end device is therefore known by means of the method according to the invention.

In a refinement of the invention, identification is carried out by reading a barcode, QR code, or an RFID chip or via NFC, wherein the barcode, the QR code, and/or the corresponding chips are arranged on or in the end device. The reading takes place immediately before the end device is dispensed.

In a further embodiment of the invention, the dispensing position is determined by means of GNSS. By means of GNSS, the dispensing position of an end device can be determined with an error of less than 10 m. In addition to GPS, other freely available satellite navigation systems (GPS=Global Positioning Systems) can be used to determine the dispensing position, e.g., the Russian GLONASS and/or the GNSS Galileo of the EU.

In a further advantageous embodiment of the invention, the ballistic data from a dispensing of the end device are determined. In a refinement of the invention, the ballistic data comprise the speed and/or direction of movement at the time of dispensing the end devices of a dispensing device used to dispense the end device. The ballistic data also include, for example, dispensing position and altitude as well as other parameters such as air pressure, humidity, air temperature, wind direction, and wind strength. The ballistic data are at least partially known during the movement of the dispensing device and/or is determined during the movement of the dispensing device.

In a further embodiment of the invention, an impact position of the end device is determined from the ballistic data and the dispensing position. The impact position refers to the position of the end device at which the end device first touches the ground and/or gets caught in a plant after the end device has been dispensed. The impact position of the end device, like the dispensing position of the end device, is different from the final position of the end device. The impact position of the end device determined by means of the ballistic data and the dispensing position of the end device deviates from the final position of the end device.

For the operation of the wildfire early detection system, precise knowledge of the final position of an end device in the monitoring area is irrelevant. By means of a comprehensive distribution of the end devices, such a scattered distribution of the end devices is achieved that the average distribution is at least 2 end devices/ha, preferably at least 5 end devices/ha, and particularly preferably at least 10 end devices/ha. It has been shown that such a distribution of end devices in the monitoring area is sufficient to detect a wildfire in the early phase of its development, for example as a smoldering fire.

In a further advantageous embodiment of the invention, the impact position determined from the ballistic data and the dispensing position is verified by means of data from triangulation measurements with other end devices. In addition, the impact position can be verified by means of data from triangulation measurements with other end devices, for example via measurements of the transit time of electromagnetic radio signals.

In a further embodiment of the invention, the end device is ejected and/or dropped by means of a dispensing device. The dispensing device is preferably part of a means of transport such as an aircraft, for example a helicopter, airplane, airship, hot air balloon. The use of ballistic missiles, such as rockets, is also possible. The dispensing device can also be part of a water or ground vehicle, also designed to be off-road, or a hovercraft. The means of transport of the dispensing device can be manned or unmanned, controlled automatically and/or autonomously and/or controllable remotely.

In a further embodiment of the invention, the end device performs sensor functions and/or gateway functions during operation of the wildfire early detection system in addition to communicating with other components of the wildfire early detection system.

In an alternative embodiment of the invention, the end device is a sensor for detecting a wildfire and has a sensor unit that detects a wildfire, for example by means of optical and/or electronic methods. In addition to heavy smoke, a wildfire produces a variety of gases, particularly carbon dioxide and carbon monoxide. The type and concentration of these gases are characteristic of a wildfire and can be detected and analyzed by means of suitable sensors. The signals detected by the sensor unit are analyzed with regard to the concentration of the composition of the gases. In addition, the temperature of the ambient air can be recorded by means of the sensor unit. In addition to the type and concentration of the gases produced in a wildfire, their temperature is an indicator of a wildfire. The occurrence and/or presence of a wildfire is concluded by combining the analyzed concentrations of the composition of the gases and/or from the analyzed temperatures. The type, composition, and temperature of the gases produced in a wildfire also indicate the occurrence of a wildfire.

LoRaWAN uses a star topology network architecture in which all the end devices communicate via the most suitable gateway. These gateways handle routing and, if more than one gateway is within range of an end device and the local network is congested, they can also redirect communication to an alternative.

The star network architecture of LoRaWAN allows the end devices to enter the energy-saving idle state for long periods of time, thereby ensuring that the battery of the end devices is put under as little load as possible and can therefore be operated for several years without having to change the battery. The gateway functions as a bridge between simple protocols optimized for battery life (LoRa/LoRaWAN), which are better suited for resource-limited end devices, and the Internet Protocol (IP), which is used to provide IoT services and applications. After the gateway has received the data packets, such as measurement data, from the end device via LoRa/LoRaWAN, it sends them via the Internet Protocol (IP) to a network server, which in turn has interfaces to IoT platforms and applications.

An end device can also be designed in such a way that, in addition to the sensor function, it also carries out gateway functions. The wildfire early detection system then only requires a single component in addition to the network server to operate.

In a further embodiment of the invention, the dispensing position comprises the dispensing position itself, the dispensing position assigned to the identification of the end device, and/or data determined from the dispensing position. In addition to the actual dispensing position, the dispensing position is assigned to an identification of each individual end device. In addition, the dispensing position can also comprise the ballistic data of the dispensing position. All of these mentioned data are stored.

The method according to the invention has two alternative method steps: In the first alternative method step, a dispensing device is loaded with a large number of end devices. The dispensing device is preferably an aircraft, for example a helicopter, airplane, airship, hot air balloon. The use of ballistic missiles, such as rockets, is also possible. The dispensing device can also be part of a water or ground vehicle, also designed to be off-road, or a hovercraft. The dispensing device can be unmanned, i.e. controlled autonomously and/or remotely controllable.

In the second alternative method step, the end devices are ejected by means of the dispensing device. The dispensing device dispenses the end devices at a time individually, in batches, and/or as a whole in or over the area in which the wildfire early detection system is to work. For this purpose, the dispensing device has suitable means for determining the position of the dispensing device, for example a gyro navigation and/or GNSS system. After being dispensed by the dispensing device, the end devices are arranged in a wildfire early detection system in such a way that the wildfire early detection system can monitor an area by means of the end devices.

In a refinement of the invention, the output takes place in the direction of the intended final position of the end devices. The end devices are usually not self-propelled. The momentum exerted on the end devices during output is used to move the end devices to their intended final position.

In an advantageous embodiment of the invention, the dispensing takes place several times, in particular the dispensing is repeated. The process of dispensing is repeated often enough that the intended number of end devices are arranged in the area in which the wildfire early detection system is to work.

In a further embodiment of the invention, the dispensing device moves between a first and a second dispensing. This ensures that the end devices arranged in the dispensing device are distributed over a large spatial area.

In a further embodiment of the invention, the distance between the position of the first dispensing and the position of the second dispensing is equidistant to the distance between the position of the second dispensing and the position of a third dispensing. This also ensures that the dispensing devices are distributed as evenly as possible in the area to be monitored.

In a refinement of the invention, the dispensing device is an aircraft or is positioned in an aircraft during dispensing. Using an aircraft, a large number of end devices can be distributed quickly and evenly within the area to be monitored. At the same time, an aircraft can also reach remote areas quickly. The aircraft itself is a helicopter, airplane, airship, or hot air balloon. The use of ballistic missiles, such as rockets, is also possible. The aircraft can also be remotely controlled and/or have autonomous control, such as a drone.

In a further embodiment of the invention, dispensing takes place in batches. A plurality of end devices are therefore dispensed at one time and/or at one dispensing position. Since damage to the end devices during dispensing and in particular during impact cannot be ruled out, redundancy is achieved by dispensing in batches. A region of the area to be monitored can therefore be monitored by a plurality of end devices.

In a refinement of the invention, the batches comprise more than 2, preferably more than 5, and particularly preferably more than 10 end devices. A plurality of end devices are therefore dispensed at one time and/or at one dispensing position. A region of the area to be monitored can therefore be monitored by a plurality of end devices.

In a further embodiment of the invention, the dispensing takes place comprehensively in multiple dispensing positions. The dispensing positions are selected in such a way that a comprehensive arrangement of the ejected end devices within the wildfire early detection system is achieved.

In a further embodiment of the invention, the dispensing takes place in lines in multiple dispensing positions. The lines of the dispensing positions can also be arranged adjacent to one another in a meandering shape to cover an area in order to achieve an even coverage of the area to be monitored with the dropped end devices.

In a further embodiment of the invention, the dispensing direction comprises a directional component that is perpendicular to the direction of movement of the dispensing device. In order to achieve a comprehensive arrangement of dispensed end devices in the area to be monitored, the dispensing direction has at least one directional component that is perpendicular to the direction of movement of the dispensing device. The dispensing device preferably ejects the end devices to the sides, which are arranged perpendicular to the direction of movement of the dispensing device.

In a further embodiment of the invention, a mechanism is triggered during the flight of the end devices, which causes deceleration of the falling speed of the end devices. This reduces the risk of damage to the end devices when the end devices fall and/or fly, particularly when they hit their impact position, for example on the ground or in a plant.

In an advantageous embodiment of the invention, during the flight of the end devices, a mechanism is triggered which activates a catch device which is intended and suitable for getting caught in a plant. A catch device arranged on the end device reduces the risk of damage to the end devices and/or the gateways, at the same time, the catch device positions the end device in such a way that the sensor unit arranged in the end device is arranged at an optimal distance from the objects (plants) to be monitored.

In a refinement of the invention, a mechanism is triggered during the flight of the end devices, which causes a change in the aerodynamics in the direction of flight of the end devices. The change in aerodynamics causes a change in the direction of flight and/or fall of the end devices and/or the gateways, the ejected end devices are therefore distributed over a larger area. In addition, the ejected end devices decelerate the falling speed of the end devices, by which the risk of damage to the end devices is reduced.

In a further embodiment of the invention, a mechanism is triggered during the flight of the end devices, which causes a change in the orientation of the end devices to the direction of flight. The change in orientation causes a change in the direction of flight and/or fall of the end devices and/or the gateways, the ejected end devices are distributed over a larger area. Likewise, the ejected end devices decelerate the falling speed of the end devices, by which the risk of damage to the end devices is reduced.

The object is furthermore achieved by means of the wildfire early detection system of claim 11. Advantageous embodiments of the invention are set out in the dependent claims.

The wildfire early detection system according to the invention has a large number of end devices and a server, wherein the exact position of the end devices is unknown after the wildfire early detection system has been installed. In addition to end devices for detecting a wildfire, the wildfire early detection system comprises a server that has interfaces to IoT platforms and applications. The position of the end devices after the installation of the wildfire early detection system and in particular after the end devices have been dispensed within the monitoring area is referred to in this document as the final position.

In a refinement of the invention, the exact position of the end devices cannot be determined by elements of the wildfire early detection system. For the operation of the wildfire early detection system, precise knowledge of the final position of an end device in the monitoring area is irrelevant. By means of comprehensive dispensing of the end devices, such a scattered distribution of the end devices is achieved that the average distribution is at least 2 end devices/ha, preferably at least 5 end devices/ha, and particularly preferably at least 10 end devices/ha. It has been shown that such a distribution of end devices in the monitoring area is sufficient to detect a wildfire in the early phase of its development, for example as a smoldering fire.

In a further aspect of the invention, the end devices are distributed scattered in the monitoring area. In a refinement of the invention, the end devices are scattered in the monitoring area. This achieves a comprehensive arrangement of the end devices within the surveillance area, wherein the average density is at least 2 end devices/ha, preferably at least 5 end devices/ha, and particularly preferably at least 10 end devices/ha.

In a further embodiment of the invention, the communication path from the end devices to the server is routed via a satellite. In addition to using a network, e.g. LoRaWAN, to communicate between the end devices and a server, communication can take place via satellites.

In a further embodiment of the invention, the end devices have a sensor, an energy supply, and a communication unit. To be able to install and operate the end device in inhospitable and especially rural areas far away from energy supplies, the end device is equipped with a self-sufficient energy supply. The energy supply is a super capacitor, in the simplest case, a battery can also be used, which can also be designed to be rechargeable.

The use of solar cells is somewhat more complex and cost-intensive, but is an energy supply E that offers a very long service life for the end device. In addition to the energy conversion by the solar cell, a memory and power electronics are also arranged in the end device ED. In addition, an end device has the actual sensor unit, which uses a temperature sensor to record the temperature of the ambient air and thus detects a wildfire. The sensor unit can also be designed in two stages and have a plurality of sensors for detecting a wildfire.

In addition to heavy smoke, a wildfire produces a variety of gases, particularly carbon dioxide and carbon monoxide. The type and concentration of these gases are characteristic of a wildfire and can be detected and analyzed by means of suitable sensors. The signals recorded by the sensor unit are analyzed with regard to the concentration of the composition of the gases. If a concentration of the gases is exceeded, a wildfire is detected.

In addition, the temperature of the gases can be analyzed by means of the sensor unit. In addition to the type and concentration of the gases produced in a wildfire, their temperature is an indicator of a wildfire. The occurrence and/or presence of a wildfire is concluded by combining the analyzed concentrations of the composition of the gases and/or from the analyzed temperatures. The type, composition, and temperature of the gases produced in a wildfire also indicate the occurrence of a wildfire. This makes it possible to detect an emerging wildfire and to combat it at an early stage.

The end device additionally has the communication device. By means of the communication device, messages from the end device, in particular measurement data and the ID signal, are sent wirelessly as a data packet to a satellite or, in the case of using a LoRaWAN, to a gateway by means of a single-hop connection or frequency modulation.

In a further aspect of the invention, the communication unit of the end devices has only one transmitting device. The communication unit and thus the end device can therefore send but not receive data. By means of the communication unit, in particular the ID of the end device is sent immediately after reaching an final position within the wildfire early detection system and optionally additionally at defined intervals in order to signal the functionality of the end device. In particular, measurement data of the sensor unit arranged in the end device are sent by means of the communication unit, by means of which a wildfire can be determined. Due to the lack of a receiving unit, the end device can be designed to be lighter, simpler, and more cost-effective, and power consumption is also reduced. In an advantageous refinement of the invention, the communication unit of the end devices is suitable for satellite communication.

The end device is therefore designed to be lighter, simpler, and more cost-effective, and its power consumption is also reduced. In a further advantageous embodiment of the invention, the end device has a mass of less than 500 g, preferably less than 250 g, and particularly preferably less than 200 g.

The end device according to the invention has a self-sufficient energy supply, a communication device, and a braking device which is intended and suitable for decelerating the falling speed of the end device.

By means of the self-sufficient energy supply, end devices are operable autonomously without a supply network. Therefore, end devices and first gateways can be distributed and networked, particularly in impassable areas that cannot be reached using conventional radio networks. In the simplest case, the energy supply is a battery, which can also be designed to be rechargeable. The use of solar cells is somewhat more complex and cost-intensive, but offers a very long service life.

By means of the communication device, messages, for example measurement data, are exchanged between the end device and the gateway.

The risk of damage to the end devices when the end devices fall and/or fly, particularly when they hit their impact position, for example on the ground or in a plant, is reduced by means of the braking device.

In a further embodiment of the invention, the cW value of the end device is different in two different directions. The CW value is a dimensionless measure of the flow resistance of a body around which a medium flows. A different cW value in different directions causes an angular momentum on the end device and thus a change in the direction of flight and/or fall of the end devices and/or the gateways, the ejected end devices are therefore distributed over a larger area.

In a further embodiment, the braking device is intended and suitable for changing the air resistance of the end device. In particular, the braking device increases the air resistance of the end device. This reduces the risk of damage to the end devices when the end devices fall and/or fly, particularly when they hit their impact position, for example on the ground or in a plant.

In a further embodiment of the invention, the braking device has a mechanism which is intended and suitable for changing the orientation of the end device to a direction of flight of the end device. The change in orientation causes a change in the direction of flight and/or fall of the end devices and/or the gateways, the ejected end devices are distributed over a larger area. In addition, the ejected end devices decelerate the falling speed of the end devices, by which the risk of damage to the end devices is reduced.

In a refinement of the invention, the braking device has a mechanism that is intended and suitable for changing the direction of flight of the end device; the ejected end devices are distributed over a larger area.

In an advantageous embodiment of the invention, the braking device has a mechanism which is intended and suitable for decelerating the falling speed and/or flight speed of the end device during a flight and/or fall of the end device, by which the risk of damage to the end devices when striking their impact position, for example on the ground or in a plant, is reduced.

In a further embodiment of the invention, the braking device has a mechanism that is intended and suitable for getting caught in a plant. A catch device arranged on the end device reduces the risk of damage to the end devices and/or the gateways; at the same time, the catch device positions the end device in such a way that the sensor unit arranged in the end device is arranged at an optimal distance from the objects (plants) to be monitored.

In a further embodiment of the invention, the braking device has a parachute, a wing, a cable device, and/or a net. The braking device reduces the fall speed and/or flight speed of the end device during a flight and/or fall of the end device, by which the risk of damage to the end devices when striking their impact position, for example on the ground or in a plant, is reduced. Parachute, cable device, and net are also suitable to act as a catch device to get the end device caught in a plant.

In addition, the braking device can have a so-called ballute, a parachute-like braking parachute system, which is also used to generate air resistance, but has advantages especially when used in low air density and in the supersonic range. Ballutes have a balloon-like central body surrounded by an annular tube. The ring ensures a defined separation of the flow and thus ensures a stable flight attitude. The initial deployment is usually assisted by active inflation by means of a gas cartridge or a small pyrotechnic propellant. Appropriately attached air inlets then ensure slight excess pressure in the interior by way of ram air to prevent collapse due to the surrounding outside air flow.

The end device according to the invention of a wildfire early detection system is alternatively designed with a self-sufficient energy supply, a communication device, and a device for changing the external shape of the end device.

The device for changing the external shape of the end device causes a change, in particular an increase, in the air resistance of the end device. This reduces the risk of damage to the end devices when the end devices fall and/or fly, particularly when they hit their impact position, for example on the ground or in a plant.

The device for changing the external shape of the end device also or additionally causes a change in the orientation of the end devices during their flight and/or fall. This results in a change in the direction of flight and/or fall of the end devices; the ejected end devices are distributed over a larger area.

In a refinement of the invention, the device for changing the external shape is intended and suitable for changing the air resistance of the end device. In particular, the braking device increases the air resistance and thus the flight and/or fall speed of the end device. This reduces the risk of damage to the end devices when the end devices fall and/or fly, particularly when they hit their impact position, for example on the ground or in a plant.

In an advantageous embodiment of the invention, the device for changing the external shape is intended and suitable for reducing the falling speed of the end device in free fall, by which the risk of damage to the end devices when striking their impact position, for example on the ground or in a plant, is reduced.

In a further embodiment of the invention, the device for changing the external shape is intended and suitable for changing the orientation of the end device in a free fall. This results in a change in the direction of flight and/or fall of the end devices; the ejected end devices are distributed over a larger area.

In a refinement of the invention, the device for changing the external shape has a folding and/or deployment mechanism. The folding and/or deployment mechanism causes an irreversible unfolding or deployment of the device to change the external shape. The folding and/or deployment mechanism is triggered by, for example, a timer, a signal, for example electromagnetic, or a mechanical event, for example by the air flow acting on the end device.

In an advantageous embodiment of the invention, the folding and/or deployment mechanism has a parachute, wings, a net, or a cable device. Parachute, wings, a net, or a cable device reduces the fall speed and/or flight speed of the end device during a flight and/or fall of the end device, by which the risk of damage to the end devices when striking their impact position, for example on the ground or in a plant, is reduced. Parachute, cable device, and net are also suitable to function as a catch device to get the end device caught in a plant.

The end device according to the invention of a wildfire early detection system is alternatively designed having a self-sufficient energy supply, a communication device, and a device for changing the orientation of the end device in a free fall.

The device for changing the orientation of the end device in a free fall changes the orientation of the end device in a free fall. This results in a change in the direction of flight and/or fall of the end devices; the ejected end devices are distributed over a larger area.

In a refinement of the invention, the device for changing the orientation of the end device in a free fall is intended and suitable for changing the air resistance of the end device. In particular, the device for changing the orientation of the end device in a free fall increases the air resistance and thus the flight and/or falling speed of the end device. This reduces the risk of damage to the end devices when the end devices fall and/or fly, particularly when they hit their impact position, for example on the ground or in a plant.

In a further embodiment of the invention, the device for changing the orientation of the end device in a free fall is intended and suitable for reducing the falling speed of the end device in free fall. This reduces the risk of damage to the end devices when the end devices fall and/or fly, particularly when they hit their impact position, for example on the ground or in a plant.

In a further embodiment of the invention, the device for changing the orientation of the end device in a free fall is intended and suitable for changing the external shape of the end device. This results in a change in the direction of flight and/or fall of the end devices; the ejected end devices are distributed over a larger area.

In an advantageous embodiment of the invention, the device for changing the orientation of the end device in a free fall has a folding and/or deployment mechanism. The folding and/or deployment mechanism causes an irreversible unfolding or deployment of the device to change the orientation of the end device. The folding and/or deployment mechanism is triggered by, for example, a timer, a signal, for example electromagnetic, or a mechanical event, for example by the air flow acting on the end device.

In a refinement of the invention, the folding and/or deployment mechanism has a parachute, wings, a net, or a cable device.

Parachute, wings, a net, or a cable device reduces the fall speed and/or flight speed of the end device during a flight and/or fall of the end device, by which the risk of damage to the end devices when striking their impact position, for example on the ground or in a plant, is reduced. Parachute, cable device, and net are also suitable to function as a catch device to get the end device caught in a plant.

The end device according to the invention of a wildfire early detection system is alternatively designed having a self-sufficient energy supply, a communication device, and a catch device. According to the invention, the catch device is intended and suitable for getting caught in a plant.

A catch device arranged on the end device reduces the risk of damage to the end devices and/or the gateways; at the same time, the catch device positions the end device in such a way that the sensor unit arranged in the end device is arranged at an optimal distance from the objects (plants) to be monitored.

In a refinement of the invention, the catch device has a folding and/or deployment mechanism. The folding and/or deployment mechanism causes the catch device of the end device to be irreversibly unfolded or deployed. The folding and/or deployment mechanism is triggered by, for example, a timer, a signal, for example electromagnetic, or a mechanical event, for example by the air flow acting on the end device.

In a refinement of the invention, the folding and/or deployment mechanism has a parachute, wings, a net, or a cable device. Parachute, wings, a net, or a cable device reduces the fall speed and/or flight speed of the end device during a flight and/or fall of the end device, by which the risk of damage to the end devices when striking their impact position, for example on the ground or in a plant, is reduced. Parachute, cable device, and net are also suitable to function as a catch device to get the end device caught in a plant.

In a further embodiment of the invention, the catch device is intended and suitable for changing the air resistance of the end device. In particular, the catch device increases the air resistance and thus the flight and/or fall speed of the end device. This reduces the risk of damage to the end devices when the end devices fall and/or fly, particularly when they hit their impact position, for example on the ground or in a plant.

In a further embodiment of the invention, the catch device is intended and suitable for reducing the falling speed of the end device in free fall, by which the risk of damage to the end devices when striking their impact position, for example on the ground or in a plant, is reduced.

In a further embodiment of the invention, the catch device is intended and suitable for changing the external shape of the end device. Changing the external shape of the end device also or additionally causes a change in the orientation of the end devices during their flight and/or fall. This results in a change in the direction of flight and/or fall of the end devices; the ejected end devices are distributed over a larger area.

### DESCRIPTION OF THE EXEMPLARY EMBODIMENTS

Exemplary embodiments of the dispensing device according to the invention, the wildfire early detection system installation device according to the invention, and the method according to the invention for installing a wildfire early detection system are shown schematically in simplified form in the drawings and are explained in more detail in the following description.

In the figures:

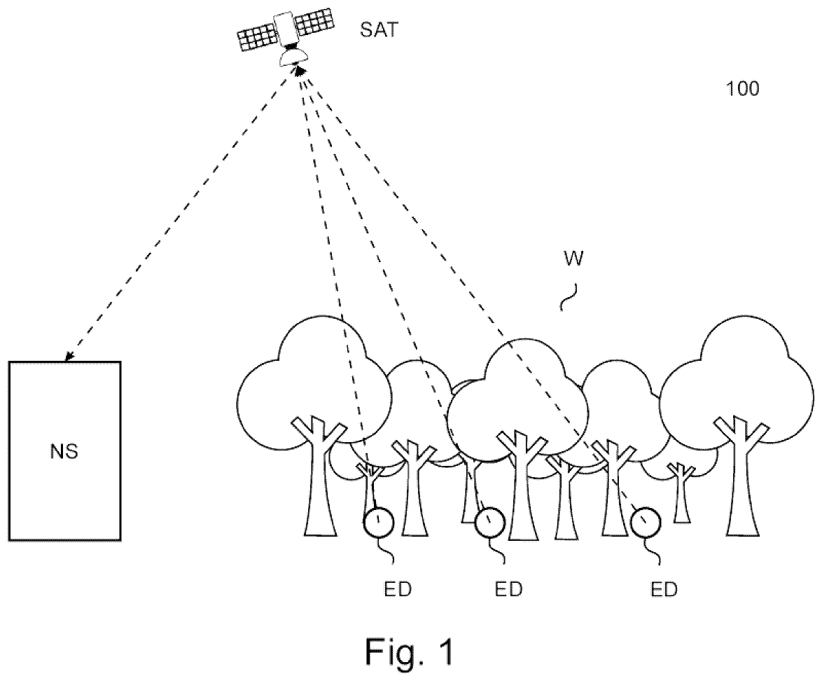

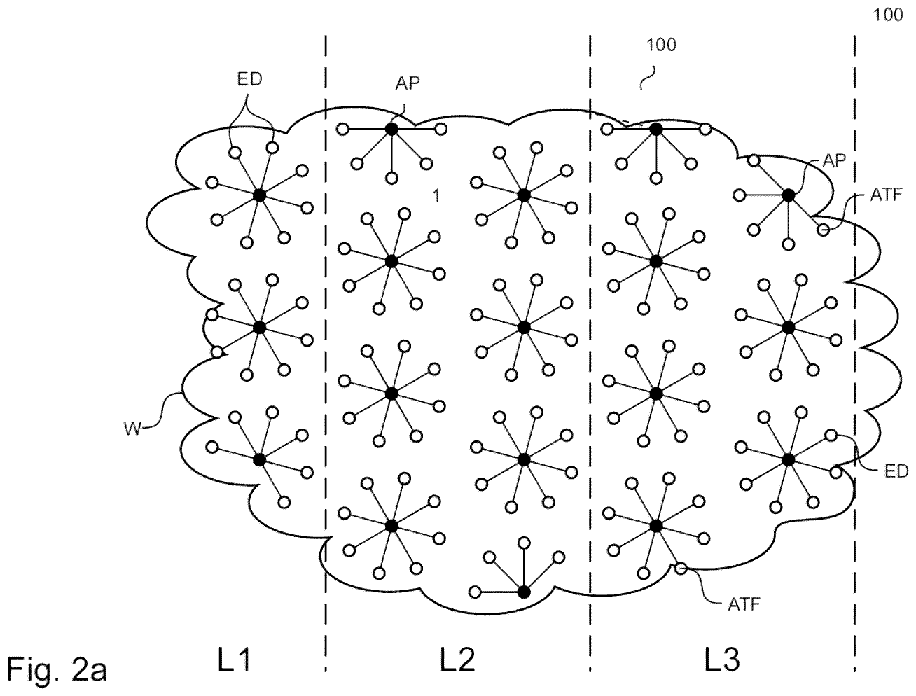

FIG. 1: shows a wildfire early detection system according to the invention, connection via satellite

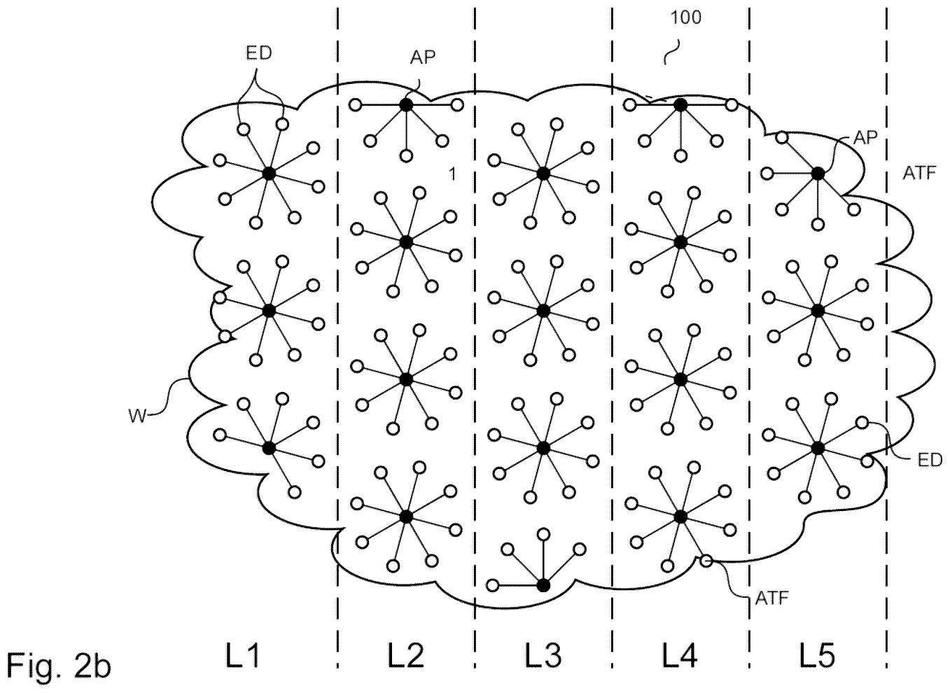

FIG. 2 a: shows a wildfire early detection system according to the invention, connection via satellite

FIG. 2 b: shows a wildfire early detection system according to the invention, three output lines

FIG. 2 c: shows a distribution of the end devices in the wildfire early detection system, deviation of impact position-final position

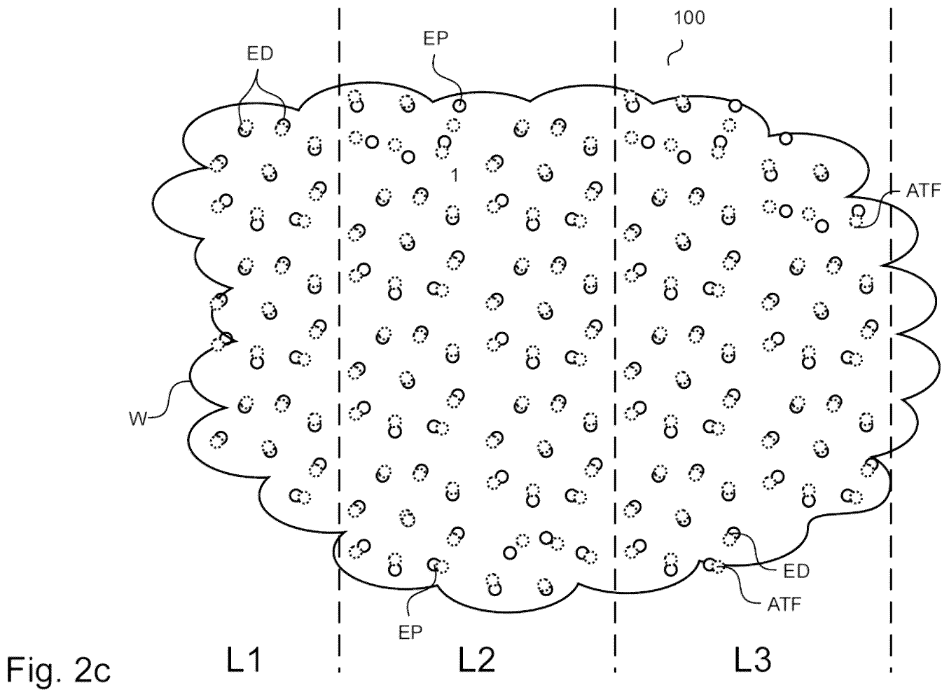

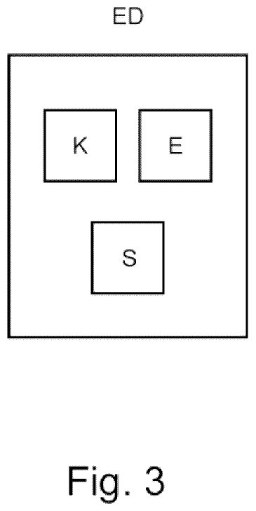

FIG. 3: shows an end device according to the invention

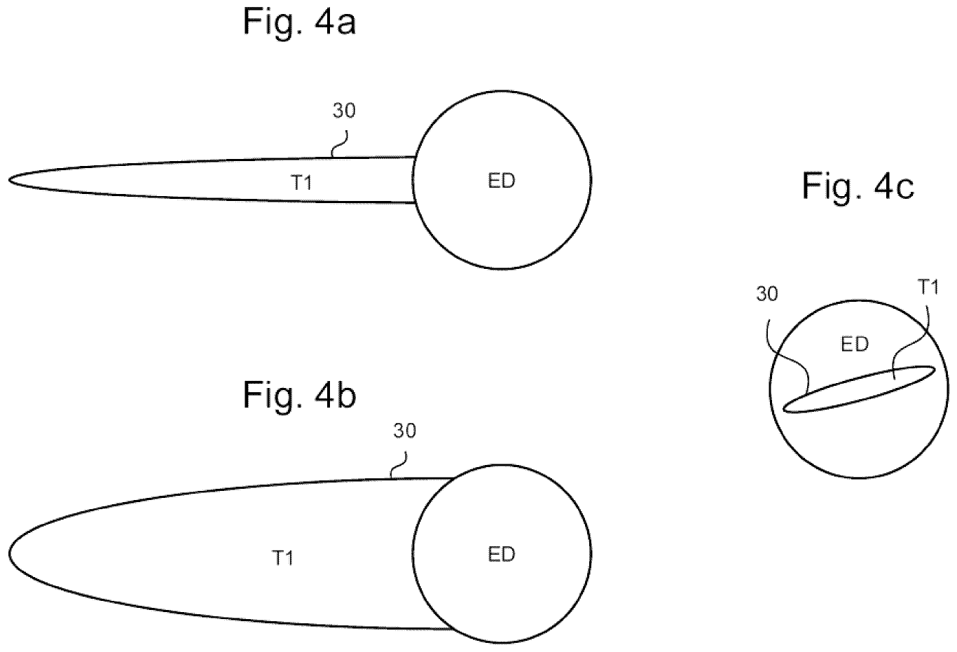

FIG. 4 a: shows a side view of a braking device

FIG. 4 b: shows a top view of a braking device

FIG. 4 c: shows a side view of a braking device

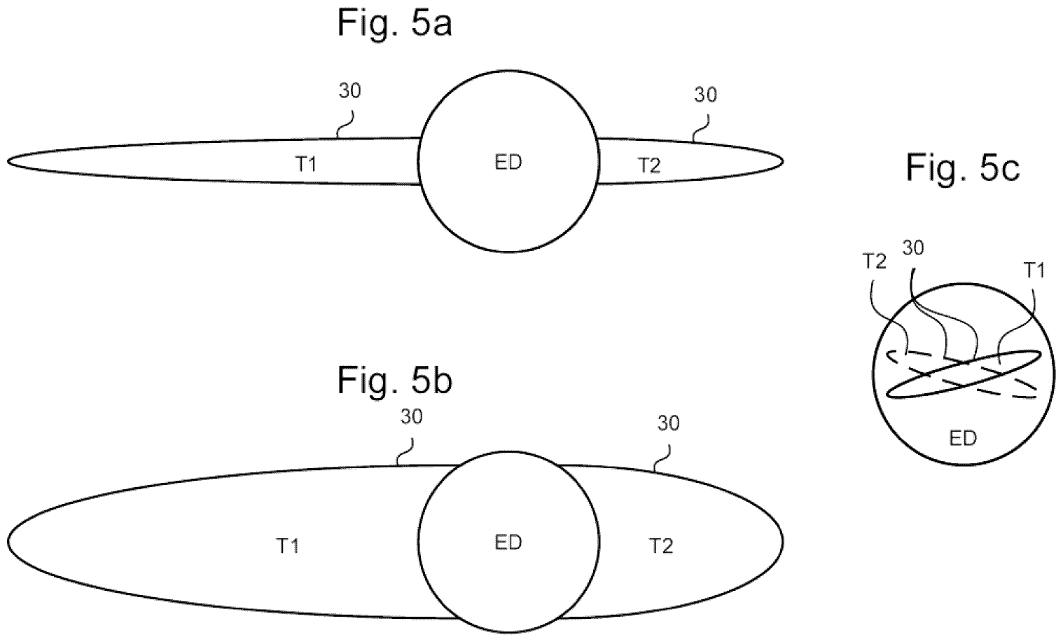

FIG. 5 a: shows a side view of an alternative embodiment of a braking device

FIG. 5 b: shows a top view of an alternative embodiment of a braking device

FIG. 5 c: shows a side view of an alternative embodiment of a braking device

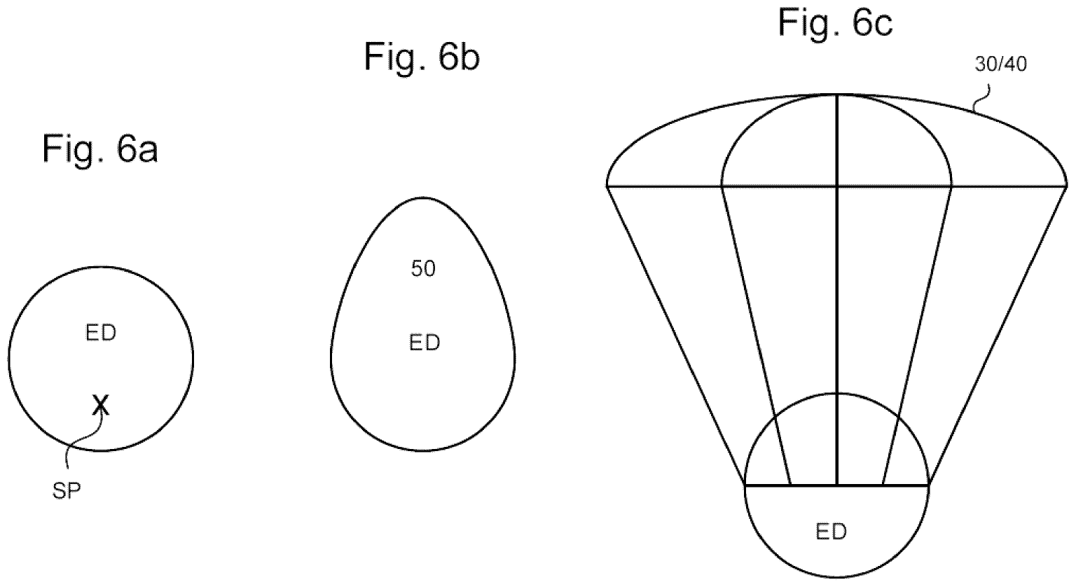

FIG. 6 a: shows a device for changing the orientation of an end device

FIG. 6 b: shows an alternative embodiment of a device for changing the orientation of an end device

FIG. 6 c: shows an alternative embodiment of a device for changing the external shape of an end device

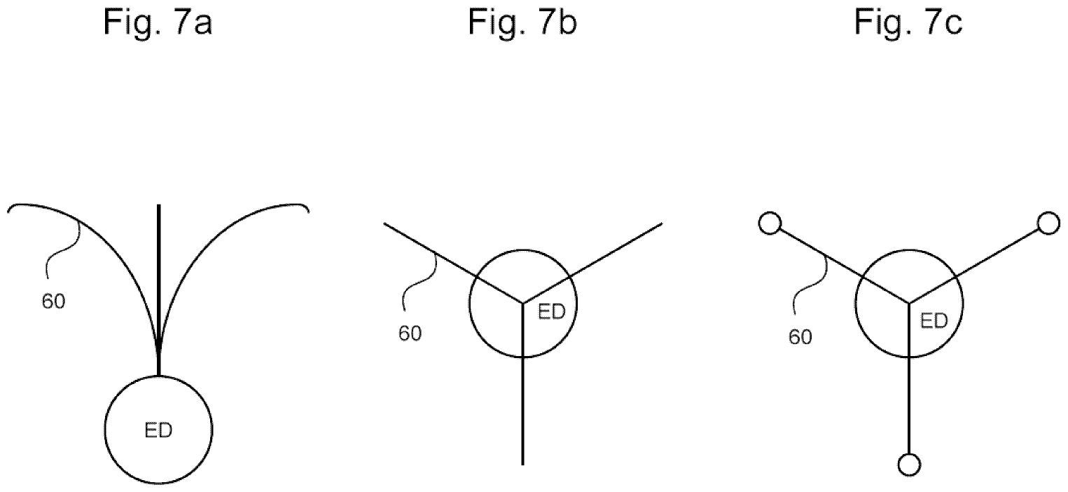

FIG. 7 a: shows a side view of a catch device

FIG. 7 b: shows a top view of a catch device

FIG. 7 c: shows a top view of a catch device

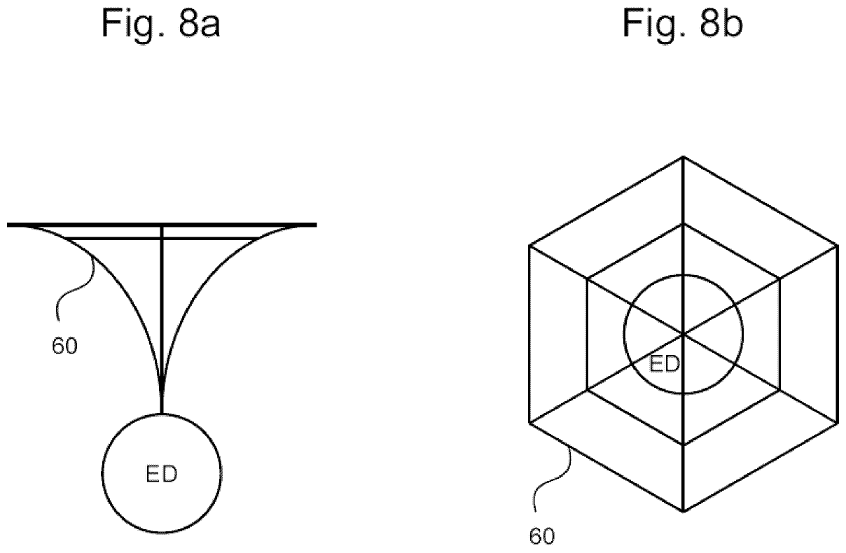

FIG. 8 a: shows a side view of a further embodiment of a catch device

FIG. 8 b: shows a top view of a further embodiment of a catch device

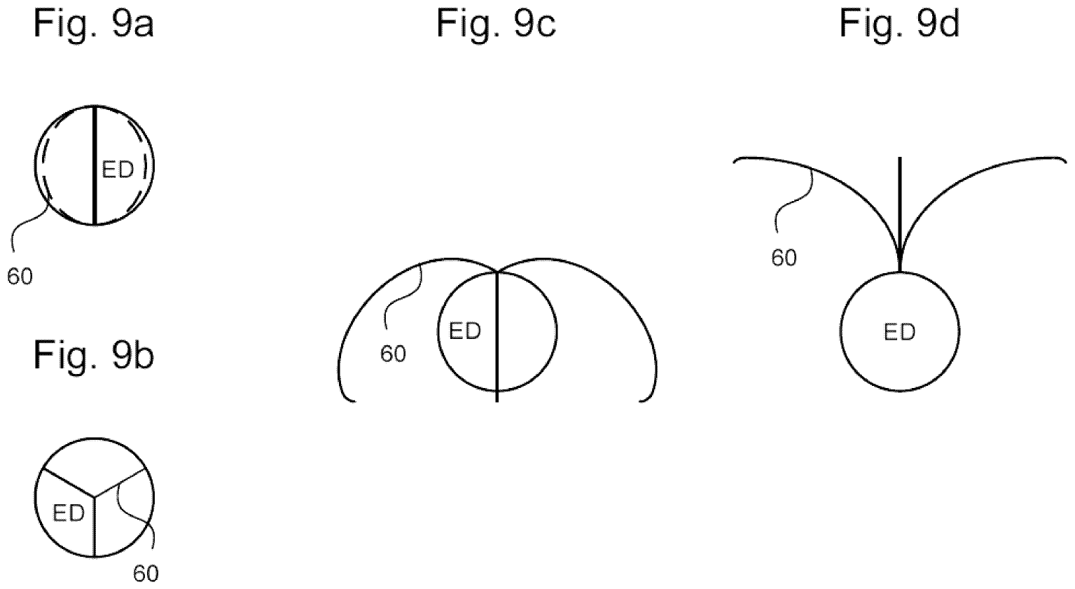

FIG. 9 a: shows a side view of a further embodiment of a catch device, folded in

FIG. 9 b: shows a top view of a further embodiment of a catch device, folded in

FIG. 9 c: shows a side view of a further embodiment of a catch device, folded out

FIG. 9 d: shows a side view of a further embodiment of a catch device, folded out

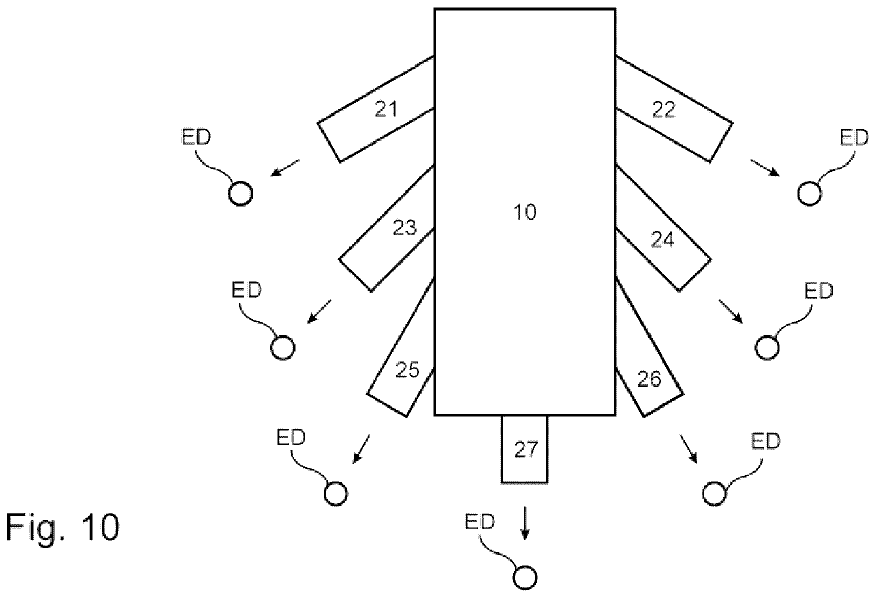

FIG. 10: shows a top view of a wildfire early detection system installation device according to the invention

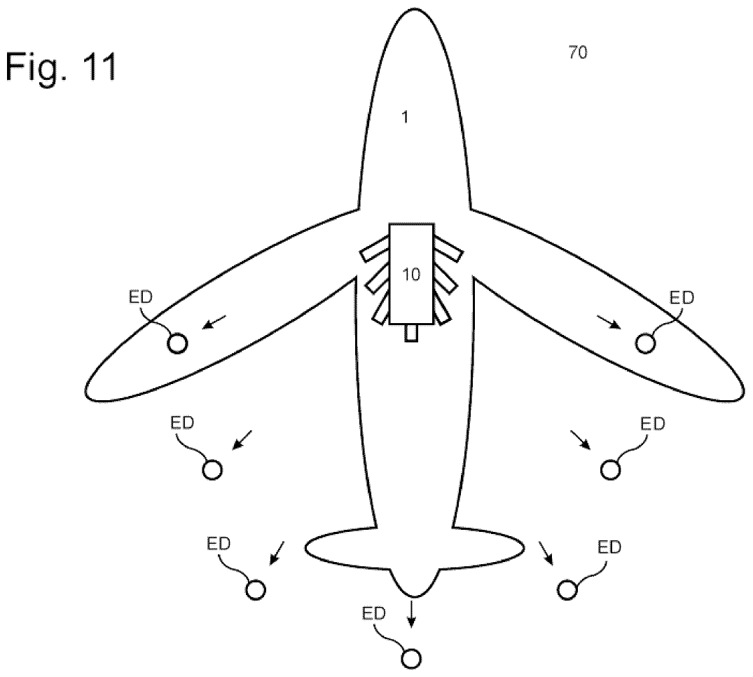

FIG. 11: shows a top view of a dispensing device according to the invention

FIG. 1 shows a further exemplary embodiment of a wildfire early detection system 100 according to the invention. In this exemplary embodiment, each end device ED is arranged in a final position on the ground of the monitoring area W, in this and all other exemplary embodiments a forest, but the end devices ED can also have final positions EP at a distance from the ground in that they are arranged in the plants by means of catch devices 60 (see FIG. 7, FIG. 8, FIG. 9). The end devices ED are directly connected to a satellite SAT and, after reaching the final position EP of the end device ED, send an ID signal and, during operation of the wildfire early detection system 100, measurement data from the sensor unit S arranged in the end device ED to the central server NS connected to the satellite SAT.

An exemplary embodiment of a wildfire early detection system 100 according to the invention in the monitoring area W and the end devices ED arranged therein is shown in FIG. 2. To install the wildfire early detection system 100, a dispensing device 10 (see FIGS. 10, 11) is loaded with a large number of end devices ED. The end devices ED are dispensed by means of the dispensing device 10. The end devices ED are dropped in batches (FIG. 2 a) in such a way that the dispensing device 10 covers an equal distance between the individual drops of a batch. The dispensing trajectories of the individual end devices ED of a batch are different, the end devices ED of a batch therefore have different impact positions ATF. The individual drops can also take place in multiple dispensing positions AP in such a way that multiple dispensing positions AP each lie along a drop line L1, L2, L3, L4, L5 (FIG. 2 b). The drop line L1 has a plurality of dispensing positions AP, each of a batch of end devices ED, as do the drop lines L2, L3, L4 and L5. In this way, a comprehensive distribution of the end devices ED is achieved.

During each of the multiple drops, a batch of nine end devices ED is dropped. The batches have more than two, preferably more than five, and particularly preferably more than ten end devices ED in such a way that the drop takes place comprehensively, in other words the installed wildfire early detection system 100 has end devices ED at the most regular spatial distances possible from one another (FIG. 2 c).

For the wildfire early detection system 100 to function correctly, knowledge of the final position EP of the end device ED within the wildfire early detection system 100 is important. In the simplest case, the end device ED itself has a GNSS system and transmits its final position EP in the wildfire early detection system 100 to the Internet network server NS. However, the GNSS system requires electrical energy and can fail, especially during ejection and the impact of the end device ED on the ground.

Therefore, according to the invention, the determination and calculation of the impact position ATF of the end device ED takes place within the wildfire early detection system 100. The impact position ATF is different from the (true) final position EP of the end device ED, which is not determined by means of the method according to the invention for determining the position of an end device ED, in contrast to the impact position ATF of an end device ED. The final position EP has a deviation from the impact position ATF of the end device ED.

For the operation of the wildfire early detection system 100, precise knowledge of the final position EP of an end device ED in the monitoring area W is irrelevant. By means of comprehensive dispensing of the end devices ED by the dispensing device 10, such a scattered distribution of the end devices is achieved that the average distribution is at least 2 end devices ED/ha, preferably at least 5 end devices ED/ha, and particularly preferably at least 10 end devices ED/ha. In this exemplary embodiment, the average distribution of the end devices ED is 9/ha. It has been shown that such a distribution of end devices ED in the monitoring area W is sufficient to detect a wildfire in the early phase of its development, for example as a smoldering fire.

Each end device ED stored in the reservoir has a unique identifier (ID). Each ID of each end device ED is stored on the network server NS. To determine the position of an end device ED after reaching the final position of the end device ED, the end device ED is first uniquely identified. This is done by reading a barcode arranged on the end device ED. The end device ED can also have an RFID chip, the identifier of which is read by means of a reader based on Near Field Communication (NFC).

When the end device ED is ejected, the dispensing position AP is determined. The position of the means of transport 1 is usually constantly recorded, also in order to control the movement of the means of transport 1. At the time of ejection of the end device ED, its dispensing position AP is determined by means of a GNSS system arranged in the means of transport 1 and assigned to the respective end device ED. Dispensing position AP and assigned identification of the end device ED are stored.

The determination and calculation of the impact position ATF of an end device ED is carried out by means of the ballistic data at the time the end device ED is dispensed. The ballistic data include, for example, direction of movement, drop position and height, speed of the dispensing device 10 and the end devices ED at the time of dispensing of the end devices ED, as well as other parameters such as air pressure, air humidity, air temperature, wind direction, and wind strength. The ballistic data are at least partially known during the movement of the means of transport 1 and read in by the database and/or are determined during the movement of the means of transport 1, for example by means of the position determination system of the means of transport 1.

After reaching the final position of the end device ED, the end device ED sends an ID signal to the central server NS, on which the final position is stored together with the ID of the respective end device ED. In addition, the impact position can be verified by means of data from triangulation measurements with other end devices ED, for example via measurements of the time of flight of electromagnetic radio signals.

The wildfire early detection system 100 can have, instead of satellite communication (see FIG. 1), a mesh gateway network arranged in a forest W that uses the technology of a LoRaWAN network. The wildfire early detection system 100 then has a large number of end devices ED, which are connected to gateways via a single-hop connection FSK. The gateways are connected to each other and partly to border gateways. The border gateways are connected to the Internet network server NS, either via a wired connection WN or via a wireless connection by means of the Internet protocol IP. The LoRaWAN network has a star-shaped architecture in which message packets are exchanged between the end devices ED having the sensors for detecting a wildfire and a central Internet network server NS by means of gateways. The end devices ED can also carry out its functions like a gateway.

FIG. 3 schematically shows the structure of the end devices ED arranged in the wildfire early detection system 100. Each end device ED arranged in the wildfire early detection system 100 has a separate, i.e., unique ID, by means of which the respective end device ED is uniquely identifiable.

The end device ED is a sensor for detecting a wildfire. To be able to install and operate the end device ED in inhospitable and especially rural areas far away from energy supplies, the end device ED is equipped with a self-sufficient energy supply E. The energy supply E is a super capacitor, in the simplest case, a battery can also be used, which can also be designed to be rechargeable.

The use of solar cells is somewhat more complex and cost-intensive, but offers a very long service life for the end device ED. In addition to the energy conversion by the solar cell, a memory and power electronics are also arranged in the end device ED. In addition, an end device ED has the actual sensor unit S, which uses a temperature sensor to record the temperature of the ambient air and thus detects a wildfire. The sensor unit S can also be designed in two stages and have a plurality of sensors for detecting a wildfire.

In addition to heavy smoke, a wildfire produces a variety of gases, particularly carbon dioxide and carbon monoxide. The type and concentration of these gases are characteristic of a wildfire and can be detected and analyzed using suitable sensors. The signals recorded by the sensor unit S are analyzed with regard to the concentration of the composition of the gases. If a concentration of the gases is exceeded, a wildfire is detected.

In addition, the temperature of the gases can be analyzed by means of the sensor unit S. In addition to the type and concentration of the gases produced in a wildfire, their temperature is an indicator of a wildfire. The occurrence and/or presence of a wildfire is concluded by combining the analyzed concentrations of the composition of the gases and/or from the analyzed temperatures. The type, composition, and temperature of the gases produced in a wildfire also indicate the occurrence of a wildfire. This makes it possible to detect an emerging wildfire and to combat it at an early stage.

The end device ED additionally has the communication device K. By means of the communication device K, messages from the end device ED, in particular measurement data and the ID signal, are sent wirelessly as a data packet to a satellite SAT or a plurality of satellites SAT or, in the case of using a LoRaWAN, to a gateway G by means of a single-hop connection FSK via LoRa (chirp frequency spread modulation) or frequency modulation. The communication device K only has a transmitting device, the end device ED can therefore not receive any data via the communication device K. The end device ED is therefore designed to be lighter, simpler, and more cost-effective, and its power consumption is also reduced. The end device ED has a mass of less than 500 g, preferably less than 250 g, and particularly preferably less than 200 g. In this exemplary embodiment, the mass of the end device ED is 50 g.

An exemplary embodiment of a braking device 30 arranged on an end device ED is shown in FIG. 4. The end device ED has a wing T1 in the form of a airfoil (FIG. 4 c) such that the center of mass of the end device ED with braking device 30 is not arranged in its geometric center point (FIGS. 4 a, b). The end device ED with arranged braking device 30 therefore has different cW values in different spatial directions.

After the end device ED with arranged braking device 30 is dispensed, it moves in the direction of the ground with increasing speed due to gravity. In flight, the end device ED with arranged braking device 30 arranged lies flat and begins to rotate around an axis extending through the end device ED. This autorotation occurs in such a way that the end device ED is on the inside and the one-sided wing T1 is on the outside. The autorotation enables the end device ED to optimally expose the wing surface to the air flow and in this way reduce the rate of descent. The autorotation of the wing T1 with the wing surface around the vertical axis generates the helical circle surface. Air flows through this helical circle surface from bottom to top.

Due to the braking device 30, not only is the falling speed of the end device ED and thus the risk of damage to the end device ED reduced, but also the direction of flight of the end device ED is changed in relation to the direction of movement of the means of transport 1, for example due to the prevailing air direction (wind direction). The distribution of the plurality of end devices ED ejected in batches within the wildfire early detection system 100 over a larger area is thus ensured.

FIG. 5 shows a variant of the previous exemplary embodiment (see FIG. 4). The end device ED has the braking device 30 having two wings T1, T2, wherein the area of the two wings T1, T2 is different from one another. The wings T1, T2 are arranged on opposite sides of the end device ED (FIGS. 5 a, b); their cross sections are at an angle to one another (FIG. 5 c). After the end device ED with arranged braking device 30 is dropped, the end device ED is also set in rotation, the falling speed and thus the risk of damage to the end device ED are reduced.

FIG. 6 shows exemplary embodiments of devices arranged on the end device ED for changing the external shape 40 and devices arranged on the end device ED for changing the orientation 50. A simple but effective method for changing the orientation during the flight and/or fall of the end device ED after it is dropped is an arrangement of the center of mass SP not at the geometric center point of the spherical end device ED, but at a distance from it (FIG. 6 a). The air resistance of the end device ED is therefore changed during the flight and/or fall. The end device ED in this way goes into a spin during its flight and/or fall and thus changes its direction in relation to the direction of movement of the means of transport 1, by which the distribution of the plurality of end devices ED ejected in batches within the wildfire early detection system 100 over a larger area is achieved.

Another method for changing the orientation during flight and/or fall of the end device ED after it is dropped is to externally shape the end device ED into an external shape that is not spherical (FIG. 6 b). This end device ED also goes into a spin during its flight and/or fall and thus changes its direction in relation to the direction of movement of the means of transport 1.

By arranging a parachute as a braking device 30 and at the same time a device for changing the external shape 40 on the end device ED (FIG. 6 c), multiple effects are achieved. The parachute 30, 40 is usually wrapped around the end device ED and opens immediately after the end device ED is dropped. The parachute 30, 40 increases the air resistance during the flight and/or fall of the end device ED in such a way that the falling speed of the end device ED is reduced enough that the risk of damage to the end device ED upon impact with the ground is reduced.

At the same time, the air resistance of the end device ED is increased during its flight and/or fall in such a way that the end device ED is engaged by the prevailing air direction (wind direction). The distribution of the plurality of end devices ED ejected in batches within the wildfire early detection system 100 over a larger area is thus enabled.

In addition, the parachute 30, 40 can be used as a catch device 60. The parachute 30, 40 is suitable for getting caught in a plant, for example in the crown of a tree. The end device ED is then arranged within the wildfire early detection system 100 in such a way that the end device ED is at a distance from the ground. This reduces the risk of subsequent damage to the end device ED, for example from animals and/or vandalism.

A further exemplary embodiment of a catch device 60 is shown in FIG. 7. The end device ED has a spherical shape, the catch device 60 is fastened to the spherical surface (FIG. 7 a). The catch device 60 has three arms, each of which has a solid ball at one end (FIGS. 7 b, c). The catch device 60 is suitable for getting caught in a plant by the balls hooking in branches of, for example, trees.

FIG. 8 shows a further exemplary embodiment of a catch device 60, which is designed as a net. The end device ED also has a spherical shape, the catch device 60 is fastened to the spherical surface (FIG. 8 a). The net 60 has a hexagonal external shape (FIG. 8 b), wherein the meshes of the net 60 are suitable for getting caught in plants. The net 60 is wrapped around the end device ED before it is dropped and opens immediately after the end device ED is dropped. In addition, the air resistance of the end device ED is increased during its flight and/or fall and thus the flight or fall speed of the end device ED is reduced.

A further exemplary embodiment of a catch device 60 is shown in FIG. 9. The catch device 60 has a deployment and/or folding mechanism. The end device ED is also designed as a sphere. When the end device ED is stored in the reservoir of the means of transport 1 before the end device ED is dropped, the catch device 60 is folded in (FIGS. 9 a, b) and is not functional. After the end device ED has been dropped, the deployment and/or folding mechanism unfolds the catch device 60 in such a way (FIG. 9 c) that the respective ends of the catch device 60, which are designed as hooked, can catch in a plant. In this exemplary embodiment, the catch device 60 is also designed in such a way that the unfolded catch device 60 (FIG. 9 d) increases the air resistance of the end device ED during its flight and/or fall and thus reduces the flight or falling speed of the end device ED.

FIG. 10 shows a top view of a possible exemplary embodiment of a dispensing device 10. In this exemplary embodiment, the dispensing device 10 has seven ejection devices 21, 22, 23, 24, 25, 26, 27 in the form of tubes, the inner diameter of which corresponds to the outer diameter of the end devices ED to be ejected. The end devices ED are dispensed by using the travel wind It is also possible to dispense the end devices ED by means of a conveyor device, for example by means of compressed air. To install a wildfire early detection system 100 (see FIG. 3 c), the dispensing device 10 is loaded with a large number of end devices ED to be dispensed. For this purpose, the dispensing device 10 has a reservoir. The dispensing device 10 then dispenses the end devices ED.

An exemplary embodiment of a wildfire early detection system installation device 70 is shown in FIG. 11. The wildfire early detection system installation device 70 has a dispensing device 10 arranged in a means of transport 1. In this exemplary embodiment, the means of transport 1 is a flyable, autonomously controlled drone. The means of transport 1 can also be, for example, a helicopter, airplane, airship, or hot air balloon. The use of ballistic missiles, such as rockets, as the means of transport 1 is also possible. The means of transport 1 can also be a water or ground vehicle, also designed to be off-road, or a hovercraft. The means of transport 1 is preferably unmanned, autonomously controlled, and/or controllable remotely.

The dispensing device 10 also has seven ejection devices 21, 22, 23, 24, 25, 26, 27. The dispensing of the end devices ED stored in a reservoir by means of the dispensing device 10 is advantageously carried out multiple times, separated by time intervals, and takes place in lines. The ejection devices 21, 22, 23, 24, 25, 26, 27 of the dispensing device 10 are arranged such that the dispensing direction of the end devices ED has at least one directional component that is perpendicular to the direction of movement of the dispensing device 10. In this exemplary embodiment, this directional component is aligned such that the directional component points towards the ground when the aircraft 1 is in normal flight.

The wildfire early detection system installation device 70 has a controller by means of which the wildfire early detection system installation device 70 is controllable. In addition, the wildfire early detection system installation device 70 has an end device ID recognition system, using which the ID of each end device ED stored in the reservoir can be recorded and which is connected to the controller. A position determination system is also connected to the controller, by means of which the position of the wildfire early detection system installation device 70 can be determined at any time and continuously.

In addition, the wildfire early detection system installation device 70 has a database connected to the controller, on which the flight plan of the means of transport 1, the number and ID of the end devices ED stored in the reservoir, and the dispensing plan of the end devices ED, meaning when which end device is to be dispensed by means of the dispensing device 10, are stored.

To avoid damage to the end device ED after it has been dropped and before it impacts in its final position during the flight of the end device ED towards the ground, a mechanism is triggered in the end device ED which reduces the falling speed of the end device ED (see FIGS. 6-11). In addition, a catch device 60, which is suitable for getting caught in a plant, in particular in a treetop, is advantageously also activated in the end device ED after the drop and before the impact in its final position during the flight of the end device ED towards the ground.

### LIST OF REFERENCE NUMERALS

1 means of transport/vehicle
10 dispensing device
21, 22, 23, 24, 25, ejection device
26, 27
AP dispensing position
ATF impact position
EP final position
ED end device
G gateway
K communication device
E energy supply
S
S sensor unit
30 braking device
40 device for changing the external shape
50 device for changing the orientation
60 catch device
70 wildfire early detection system installation device
T1, T2 wing
SP center of mass
L1, L2, L3, L4, L5 drop line
SAT satellite
FSK frequency modulation
IP Internet protocol
MHF multi-hub wireless network
NS Internet network server
W monitoring area
WN wired connection
BGD border gateway
100 wildfire early detection system

1. A method for determining the position of an end device (ED) of a wildfire early detection system (100), comprising the steps of
identifying the end device (ED),
recording the dispensing position (AP) of the end device (ED),
assigning the dispensing position (AP) to an identified end device (ED),
storing data from the dispensing position (AP) and the identification of the end device (ED).

2. The method for determining the position of an end device (ED) of a wildfire early detection system (100) of claim 1,
characterized in that
the identification is carried out by reading a barcode, QR code, an RFID chip or via NFC.

3. The method for determining the position of an end device (ED) of a wildfire early detection system (100) of claim 1,
characterized in that
the dispensing position (AP) is determined by means of GNSS.

4. The method for determining the position of an end device (ED) of a wildfire early detection system (100) of claim 1,
characterized in that
the ballistic data of a dispensing of the end device (ED) are determined.

5. The method for determining the position of an end device (ED) of a wildfire early detection system (100) of claim 4,
characterized in that
the ballistic data comprise the speed and/or direction of movement of a dispensing device (10) used to dispense the end device (ED).

6. The method for determining the position of an end device (ED) of a wildfire early detection system (100) of claim 5,
characterized in that
an impact position (ATF) of the end device (ED) is determined from the ballistic data and the drop position (AP).

7. The method for determining the position of an end device (ED) of a wildfire early detection system (100) of claim 6,
characterized in that
the impact position (ATF) determined from the ballistic data and the release position (AP) is verified by means of data from triangulation measurements with other end devices (ED).

8. The method for determining the position of an end device (ED) of a wildfire early detection system (100) of claim 1,
characterized in that
the end device (ED) is ejected and/or dropped by means of a dispensing device (10).

9. The method for determining the position of an end device (ED) of a wildfire early detection system (100) of claim 1,
characterized in that
the end device (ED) carries out sensor functions and/or gateway functions during operation of the wildfire early detection system (100) in addition to communicating with other components of the wildfire early detection system (100).

10. The method for determining the position of an end device (ED) of a wildfire early detection system (100) of claim 1,
characterized in that
the dispensing position (AP) comprises the dispensing position assigned to the identification, the dispensing position itself, and/or data determined from the dispensing position.

11. A wildfire early detection system (100) comprising
a large number of end devices (ED)
a server (NS)
wherein the exact position of the end devices (ED) is unknown after the end device (ED) has been installed.

12. The wildfire early detection system (100) of claim 11,
characterized in that
the exact position of the end devices (ED) cannot be determined by elements of the wildfire early detection system (100).

13. The wildfire early detection system (100) of claim 11,
characterized in that
the end devices (ED) are distributed scattered in the monitoring area (W).

14. The wildfire early detection system (100) of claim 11,
characterized in that
the end devices (ED) are scattered randomly in the monitoring area (W).

15. The wildfire early detection system (100) of claim 11,
characterized in that
the communication path of the end devices (ED) to the server (NS) is routed via a satellite (SAT).

16. The wildfire early detection system (100) of claim 11,
characterized in that
the end devices (ED) have a sensor(S), a power supply (E), and a communication unit (K).

17. The wildfire early detection system (100) of claim 16,
characterized in that
the communication unit (K) of the end devices (ED) only has one transmitting device.

18. The wildfire early detection system (100) of claim 16,
characterized in that
the communication unit (K) of the end devices (ED) is suitable for satellite communication.

19. The wildfire early detection system (100) of claim 16,
characterized in that
the energy supply (E) of the end devices (ED) has an energy conversion unit and/or an energy storage device.

20. The wildfire early detection system (100) of claim 11,
characterized in that
the mass of the end devices (ED) is less than 500 g, preferably less than 250 g, and
particularly preferably less than 200 g.
